(19) United States
(12) Patent Application Publication
(10) Pub. No.: US 2002/0157115 A1
(43) Pub. Date: Oct. 24, 2002

(54) Wireless communication point of deployment module for use in digital cable compliant devices

(75) Inventor: Jin Lu, Croton-on-Hudson, NY (US)

Correspondence Address: Michael E. Marion, Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/840,818

(22) Filed: Apr. 24, 2001

(51) Int. Cl. H04N 7/173; H04N 7/16

(52) U.S. Cl. 725/131; 725/110; 725/151

(57) ABSTRACT

There is disclosed, for use in a digital cable set-top box coupled to a television set, a removable circuit apparatus for insertion into a point of deployment (POD) host interface associated with the digital cable set-top box. The removable circuit apparatus comprises: 1) a point of deployment (POD) module interface for mating with the POD host interface; and 2) RF transceiver coupled to the POD module interface for receiving an incoming baseband signal from the digital cable set-top box, upconverting the baseband signal to an outgoing RF signal, and wirelessly transmitting the outgoing RF signal to at least one wireless communication device proximate the digital cable set-top box. The RF transceiver also wirelessly receives an incoming RF signal from the at least one wireless communication device, downconverts the incoming RF signal to an outgoing baseband signal, and transmits the outgoing baseband signal to the digital cable set-top box.

### CROSS-REFERENCE TO RELATED APPLICATION

The present invention is related to that disclosed in U.S. patent application Ser. No. [Docket No. 701114], filed on [Filing Date], entitled “APPLICATION SPECIFIC POINT OF DEPLOYMENT MODULES FOR USE IN DIGITAL CABLE COMPLIANT DEVICES.” application Ser. No. [Docket No. 701114] is commonly assigned to the assignee of the present invention. The disclosure of this related patent application is hereby incorporated by reference for all purposes as if fully set forth herein.

### TECHNICAL FIELD OF THE INVENTION

The present invention is directed, in general, to digital cable compliant devices and, more specifically, to a wireless communication point of deployment (POD) module for use in a digital cable set-top box.

### BACKGROUND OF THE INVENTION

Modern electronic technology has made a wide array of communication, multimedia and information processing systems available to consumers and business. Most people are familiar with and use personal computers, television sets, AM/FM stereo receivers, video cassette recorders (VCR), digital video discs (DVD) players, video game consoles and the like. These electronic appliances are used for business purposes and for personal entertainment purposes.

Many of the functions in some of these electronic appliances are redundant to similar functions in other electronic appliances. For example, a person may view video content on a television set and on a personal computer (PC) monitor and can listen to audio on television, on stereos, on MP3 players, on cassette tape players, and the like. Similarly, a person can play a video game on the screen of a PC monitor or on the screen of a television connected to a video game control module (or play station). Additionally, there are redundant means of receiving, transmitting and distributing data among two or more devices in a home or office. For example, a consumer may use DSL service for Internet access and may install new wall wiring and a router to network several computers and other devices together. This network wiring is redundant to existing cable TV wiring that the consumer already has. It would be preferable if these redundant functions could be reduced in order to reduce a consumer's overall equipment costs.

Therefore, there is a need in the art for electronic systems that are capable of converging redundant functions performed by a variety of consumer devices. In particular, there is a need for electronic apparatuses that may be used in conjunction with conventional consumer devices to enhance the capabilities of those consumer devices. More particularly, there is a need for electronic apparatuses that may be inserted into or attached to a standard consumer electronic system to thereby enable the standard consumer electronic system to perform enhanced, non-standard applications. Advantageously, these enhanced, non-standard applications should include a wireless networking capability.

### SUMMARY OF THE INVENTION

To address the above-discussed deficiencies of the prior art, it is a primary object of the present invention to provide, for use in a digital cable set-top box capable of being coupled to a television set, a removable circuit apparatus capable of being inserted into a point of deployment (POD) host interface associated with the digital cable set-top box. According to an advantageous embodiment of the present invention, the removable circuit apparatus comprises: 1) a point of deployment (POD) module interface capable of mating with the POD host interface; and 2) RF transceiver coupled to the POD module interface capable of receiving an incoming baseband signal from the digital cable set-top box, upconverting the baseband signal to an outgoing RF signal, and wirelessly transmitting the outgoing RF signal to at least one wireless communication device proximate the digital cable set-top box and further capable of wirelessly receiving an incoming RF signal from the at least one wireless communication device, downconverting the incoming RF signal to an outgoing baseband signal, and transmitting the outgoing baseband signal to the digital cable set-top box.

According to one embodiment of the present invention, the incoming baseband signal and the incoming RF signal comprise Internet protocol (IP) data packets.

According to another embodiment of the present invention, the removable circuit apparatus further comprises: 1) a data processor coupled to the POD module interface and capable of transmitting to the digital cable set-top box at least one of an audio signal and a video signal capable of being displayed on a screen of the television set; and 2) a memory coupled to the data processor capable of storing a user POD application program executable by the data processor, wherein the user POD application is operable to cause the data processor to control operation of the RF transceiver.

According to still another embodiment of the present invention, the data processor is capable of receiving user input signals from the digital cable set-top box.

According to yet another embodiment of the present invention, the user input signals comprise infrared signals detected by an infrared sensor associated with the digital cable set-top box.

According to a further embodiment of the present invention, the removable circuit apparatus further comprises a user interface coupled to the data processor capable of receiving user inputs from a user input device coupled to the user interface.

According to a still further embodiment of the present invention, the user input device comprises a keyboard.

According to a yet further embodiment of the present invention, the user input device comprises a mouse.

In one embodiment of the present invention, the removable circuit apparatus further comprises a disk storage device capable of storing the user POD application program.

In another embodiment of the present invention, the removable circuit apparatus further comprises a disk storage device capable of storing at least one of audio files, video files, graphics files, and text files associated with the user POD application program.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art should appreciate that they may readily use the conception and the specific embodiment disclosed as a basis for modifying or designing other structures for carrying out the same purposes of the present invention. Those skilled in the art should also realize that such equivalent constructions do not depart from the spirit and scope of the invention in its broadest form.

Before undertaking the DETAILED DESCRIPTION OF THE INVENTION, it may be advantageous to set forth definitions of certain words and phrases used throughout this patent document: the terms “include” and “comprise” and derivatives thereof mean inclusion without limitation; the term “or” is inclusive, meaning and/or; the phrases “associated with” and “associated therewith” and derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates a television set and a digital cable set-top box according to one embodiment of the present invention;

FIG. 2 illustrates a digital cable set-top box and a conventional point-of-deployment (POD) module according to one embodiment of the prior art;

FIG. 3 illustrates a digital cable set-top box and a novel point-of-deployment (POD) module according to a first embodiment of the present invention; and

FIG. 4 illustrates a digital cable set-top box and a novel point-of-deployment (POD) module that has a wireless capability according to a second embodiment of the present invention.

### DETAILED DESCRIPTION OF THE INVENTION

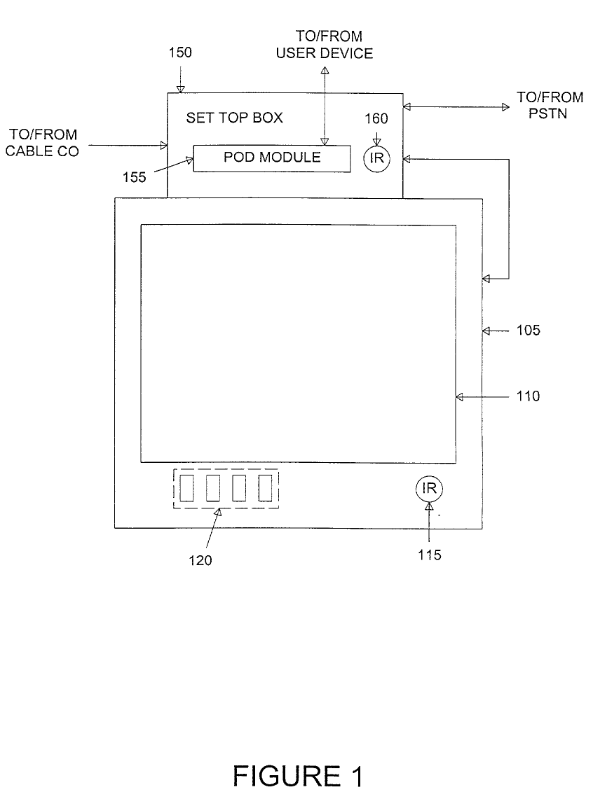

FIGS. 1 through 4 discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged digital cable compliant appliance.

FIG. 1 illustrates television set 105 and digital cable set-top box 150 according to one embodiment of the present invention. Television set 105 comprises display screen 110 for displaying cable television programming provided by a cable service provider (Cable Co.), infrared (IR) sensor 115, and a set of manual controls 120, as indicated by a surrounding dotted line. Manual controls 120 may include, among others, a power button, a volume control button, vertical and horizontal directional control buttons, a channel selection button, and the like. IR sensor 115 receives infrared (IR) control signals from a hand-held remote control manipulated by the cable subscriber. Typically, the IR control signals detected by IR sensor 115 are processed within television set 105 in order to change the channel being viewed on display screen 110, to increase or to decrease the volume, to turn television set 105 on and off, and the like. Optionally, the IR control signals detected by IR sensor 115 may be relayed to digital cable set-top box 150 in order to control the operation of digital cable set-top box 150.

In an advantageous embodiment of the present invention, digital cable set-top box 150 is a standards-based device that allows a cable subscriber to receive digital cable television service from a cable provider (Cable Co.). Digital cable set-top box 150 is a “generic” device that the cable subscriber may purchase from any one of a number of retail vendors, not merely from the cable service provider, thereby reducing the cost of such devices. The impetus for open-standard devices such as digital cable set-top box 150 was provided by the FCC's 1996 Telecom Reform Act, which required the retail availability of cable set-top boxes.

Digital cable set-top box 150 also comprises removable point-of-deployment (POD) module 155, which is provided by the cable service provider. Digital cable set-top box 150 is a “host” device with respect to POD module 155. Digital cable set-top box 150 performs conventional tuning and demodulation of incoming RF signals received from the cable service provider to thereby produce, for example, a stream of MPEG encoded digital data from which video signals may be derived.

POD module 155 typically comprises circuitry capable of performing conditional access and security functions that are proprietary and closely guarded. These functions allow selective access to basic digital cable services, such as network television broadcasts, and to premium digital cable services, such as pay-per-view programming, HBO, SHOWTIME, and the like. Typically, the cable subscriber may obtain POD module 155 only by purchasing or leasing POD module 155 from the cable service provider.

Digital cable set-top box 150 also comprises infrared (IR) sensor 160. IR sensor 160 receives infrared (IR) control signals from a hand-held remote control manipulated by the cable subscriber. Preferably, the remote control that controls digital cable set-top box 150 is the same remote control that operates television set 105. Typically, the IR control signals detected by IR sensor 160 are processed within digital cable set-top box 150 in order to change the channel being transmitted to television set 105 for viewing on display screen 110, to turn digital cable set-top box 150 and/or television set 105 on and off, and the like.

In some embodiments of the present invention, digital cable set-top box 150 may actually be integrated into television set 105. This may be particularly true in the case of advanced digital television sets, such as high-definition television (HDTV) sets. Since the functions and operations of digital cable set-top box 150 are open and well-known, television manufacturers frequently may find it advantageous to integrate digital cable set-top box 150 into television set 150, thereby reducing the amount of equipment, wiring, and set-up work required of the cable subscriber. In such embodiments, television set 105 may include an externally accessible card slot into which removable POD module 155 may be inserted.

Additionally, in some embodiments of the present invention, digital cable set-top box 150 may optionally include a telephone interface circuitry (e.g., a modem) that allows digital cable set-top box 150 to be coupled to the public switched telephone network (PSTN). In such embodiments, digital cable set-top box 150 may sand and receive commands and data that are required in order for digital cable set-top box 150 and/or POD module 155 to operate properly. In one embodiment, the cable service provider transmits the required commands and data to digital cable set-top box 150 by dialing the cable subscriber's telephone number and downloading the commands and data to digital cable set-top box 150.

Devices such as POD module 155 and digital cable set-top box 150 are described in the literature of the cable services industry and related engineering standards committees. One such document is “Proposed HOST-POD Interface Specification”, SCTE DVS/295, dated Jan. 7, 2000 and provided by the Society of Cable Telecommunications Engineers, Inc. The subject matter disclosed in Document No. SCTE DVS/2956 are hereby incorporated by reference into the present disclosure as if fully set forth herein.

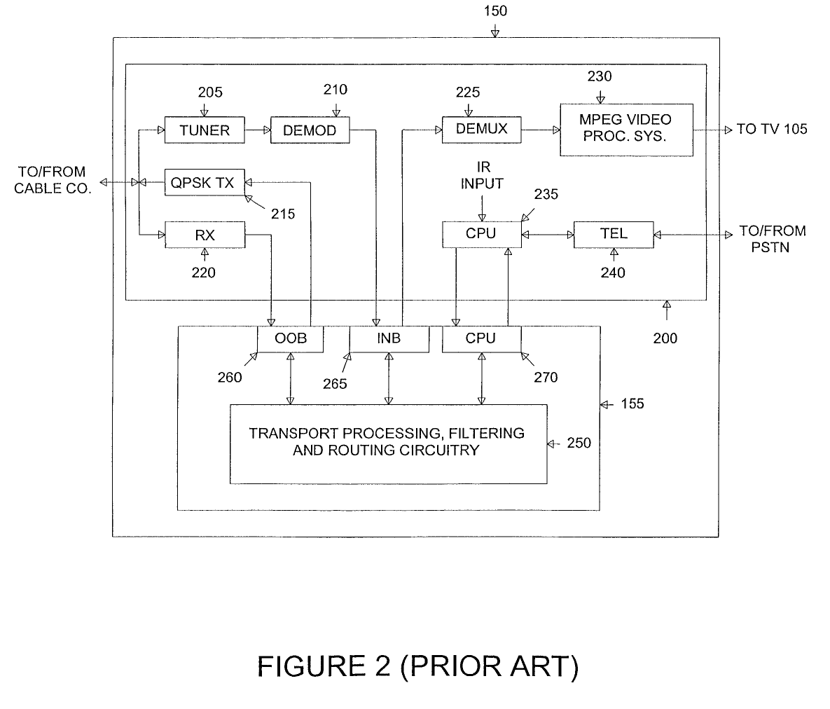

FIG. 2 illustrates digital cable set-top box 150 and conventional point-of-deployment (POD) module 155 according to one embodiment of the prior art. Digital cable set-top box 150 comprises host interface 200 which mates with conventional POD module 155. Host interface 200 comprises tuner 205, demodulation (DEMOD) circuitry 210, quadrature phase shift keying (QPSK) transmitter (TX) 215, and digital data receiver (RX) 220. Host interface 200 further comprises demultiplexer (DEMUX) 225, MPEG video processing system 230, central processing unit (CPU) 235 and telephony interface 240. Removable POD module 155 comprises transport processing, filtering and routing circuitry 250, out-of-band (OOB) signal interface 260, in-band (INB) signal interface 265, and CPU interface 270.

RF tuner 205 receives a spectrum of in-band (INB) radio frequency (RF) signals from the cable service provider and is tuned to a signal selected by the cable subscriber using the remote control. The tuned output of tuner 205 is then demodulated by demodulation circuitry 210 (using, for example, QAM demodulation) to produce a digital baseband signal that is transmitted to INB interface 265 in POD module 155. In some systems, digital cable set-top box 150 may be a two-way device. Therefore, digital cable set-top box 150 may optionally include QPSK transmitter 215, which receives from OOB interface 260 a digital baseband signal generated by POD module 155 and QPSK-modulates the digital baseband signal to produce an RF signal suitable for transmission to the cable service provider. Optionally, digital cable set-top box 150 may include digital data receiver 220, which receives an incoming stream of digital baseband data from the cable service provider and transfers it to POD module 155 via OOB interface 260.

As FIG. 2 indicates, signaling functions are split between host interface 200 and POD module 155. Host interface 200 handles open and standardized signal functions, such as RF front end processing and QPSK modulation and QAM demodulation, and POD module 155 handles proprietary and secure functions, such as data-link and medium access control (MAC) protocols, encryption and decryption of incoming and outgoing data streams, and the like.

Transport processing, filtering and routing circuitry 250 comprises circuitry capable of decoding encrypted digital baseband streams from INB interface 265 to produce, for example, a decoded MPEG digital data stream. The decoded MPEG digital data stream is then routed back to INB interface 265 and transferred to demultiplexer 225. The demultiplexed MPEG data streams are then sent to MPEG video processing system 230, which generates a conventional television signal that is sent to television set 105. Additionally, command and data signals received by optional telephony interface 240 may be processed by CPU 235 and transmitted through CPU interface 270 to transport processing, filtering and routing circuitry 250 for use, for example, in decoding encrypted video data streams, activating pay-per-view functions, enabling the filtering of premium cable programming, and the like. CPU 235 also processes infrared (IR) control signals received from the remote control by one or both of IR sensor 115 and IR sensor 160.

The present invention takes advantage of the standardized interface connections used by POD module 155 and host interface 200 to provide digital cable set-top box 150 with enhanced capabilities beyond conventional digital cable services. In particular, the present invention discloses novel application-specific point-of-deployment (POD) modules that integrate data processors and memory circuitry capable of executing such non-cable TV applications as video games (including interactive games), e-mail, word processing, and the like.

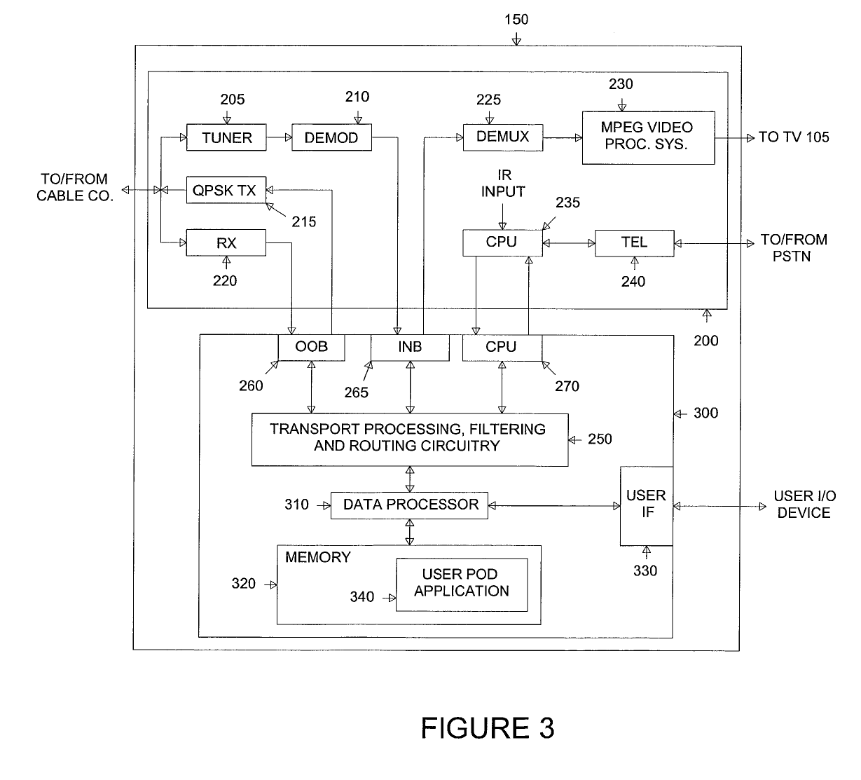

FIG. 3 illustrates digital cable set-top box 150 and novel point-of-deployment (POD) module 300 according to one embodiment of the present invention. The operation and configuration of digital cable set box 150 and POD module 300 is generally the same as described above in FIG. 2. Digital cable set-top box 150 comprises host interface 200, which mates with conventional POD module 300. As before, host interface 200 comprises tuner 205, demodulation (DEMOD) circuitry 210, quadrature phase shift keying (QPSK) transmitter (TX) 215, digital data receiver (RX) 220 demultiplexer (DEMUX) 225, MPEG video processing system 230, central processing unit (CPU) 235 and telephony interface 240. Removable POD module 300 comprises transport processing, filtering and routing circuitry 250, out-of-band (OOB) signal interface 260, in-band (INB) signal interface 265, CPU interface 270, data processor 310, memory 320, and optional user interface (IF) 330. Memory 320 stores user POD application program 340, explained below in greater detail.

RF tuner 205 receives a spectrum of in-band (INB) radio frequency (RF) signals from the cable service provider and is tuned to a signal selected by the cable subscriber using the remote control. The tuned output of tuner 205 is then demodulated by QPSK demodulation circuitry 210 (using, for example, QAM demodulation) to produce a digital baseband signal that is transmitted to INB interface 265 in POD module 300.

In some systems, digital cable set-top box 150 may be a two-way device. Therefore, digital cable set-top box 150 may optionally include QPSK transmitter 215, which receives from OOB interface 260 a digital baseband signal generated by POD module 300 and QPSK-modulates the digital baseband signal to produce an RF signal suitable for transmission to the cable service provider. Digital cable set-top box 150 also may include digital data receiver 220, which receives an incoming stream of digital baseband data from the cable service provider and transfers it to POD module 300 via OOB interface 260.

Signaling functions are split between host interface 200 and POD module 300. Host interface 200 handles open and standardized signal functions, such as RF front end processing and QPSK modulation and demodulation, and POD module 300 handles proprietary and secure functions, such as data-link and medium access control (MAC) protocols, encryption and decryption of incoming and outgoing data streams, and the like.

Transport processing, filtering and routing circuitry 250 comprises circuitry capable of decoding encrypted digital baseband streams from INB interface 265 to produce, for example, a decoded MPEG digital data stream, which is then routed back to INB interface 265 and transferred to demultiplexer 225. The demultiplexed MPEG data streams are then sent to MPEG video processing system 230, which generates a conventional television signal that is sent to television set 105. Additionally, command and data signals received by optional telephony interface 240 may be processed by CPU 235 and transmitted through CPU interface 270 to transport processing, filtering and routing circuitry 250 for use, for example, in decoding encrypted video data streams, activating pay-per-view functions, enabling the filtering of premium cable programming, and the like. CPU 235 also processes infrared (IR) control signals received from the remote control by one or both of IR sensor 115 and IR sensor 160.

In accordance with the principles of the present invention, the capabilities of POD module 300 are enhanced beyond the standard controlled access and security features normally performed by POD modules used in digital television set-top boxes. POD module 300 may be adapted to perform specific applications according to user POD application program 340 executed by data processor 310. For example, in one embodiment of the present invention, POD module 300 may be a video game cartridge that is inserted into digital cable set-top box 150. The user plays a video game displayed on screen 110 using a joystick or other control device that is coupled to user interface 330. In another embodiment of the present invention, POD module 300 may be an e-mail application that the user operates using a keyboard and/or mouse coupled to user interface 330.

The specific application performed by POD module 300 may be a “two-way” application that sends data to the digital cable service provider via QPSK transmitter 215 and receives data from the digital cable service provider via receiver 220 (out-of-band signals) or tuner 205 and demodulation circuitry 210 (in-band signals). Examples of two-way applications include e-mail and interactive video games that may be played through the Internet.

The specific application performed by POD module 300 may be a “oneway” application that only receives data from the digital cable service provider via receiver 220 or tuner 205 and demodulation circuitry 210. Finally, the specific application performed by POD module 300 may be a “stand-alone” application that does not interact with the digital cable service provider at all. An example of a stand-alone application is a single player video game. In a stand-alone application, tuner 205, demodulation circuitry 210, QPSK transmitter 215 and receiver 220 are not used by POD module 300. Hence, OOB interface 260 may be omitted from POD module 300.

Data processor 310 receives incoming in-band and out-of-band signals from the digital cable service provider via transport processing, filtering and routing circuitry 250 and transmits outgoing signals to the digital cable service provider via transport processing, filtering and routing circuitry 250. Data processor 310 also transmits audio and video data streams generated by user POD application program 340 to television 105 via transport processing, filtering and routing circuitry 250 and demultiplexer 225. The format of the audio and video streams may further utilize the MPEG transport scheme or may simply be digitized baseband audio and video signals.

Data processor 310 may receive user inputs from the digital cable subscriber directly from user interface 330. A number of different types of user inputs may be coupled to user interface 330, including one or more of a joystick for video games, a mouse, and a keyboard. Data processor 310 also may receive user inputs indirectly from the television remote control. Data processor 310 receives IR control signals through CPU 235, CPU interface 270 and transport processing, filtering and routing circuitry 250.

POD application 340 determines the type of application (or applications) performed by POD module 300. As stated above, user POD application 340 may comprise a video game application, including a stand-alone video game that is played on the display screen 110 by a single player and an interactive game that is played by two or more players coupled together by the Internet via the cable service provider network. User POD application 340 also may comprise an e-mail application and/or a word processor application. The alphanumeric characters entered by the user are displayed by the e-mail or word processing application on display screen 110, thereby eliminating the need for a separate computer monitor.

In an advantageous embodiment of the present invention, memory 320 may comprise random access memory (RAM) as well as a disk storage device capable of storing user POD application program 340 and one or more of audio files, video files, graphics files and text files used by user POD application program 340.

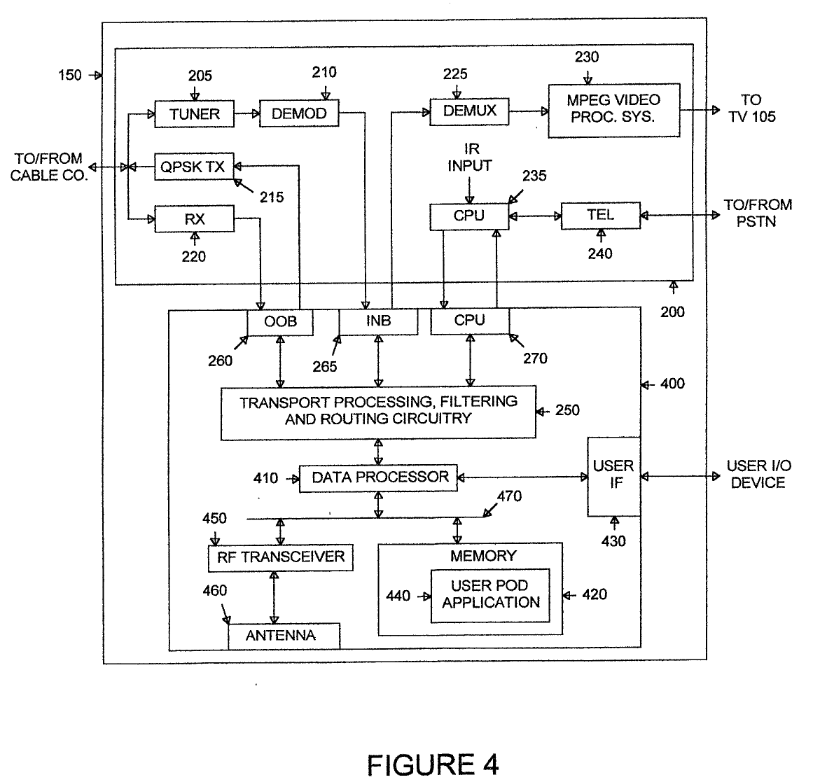

FIG. 4 illustrates digital cable set-top box 150 and removable point-of-deployment (POD) module 400, which has a wireless communication capability according to another embodiment of the present invention. The operation and configuration of digital cable set box 150 and POD module 400 is generally the same as described above in FIGS. 2 and 3. Digital cable set-top box 150 comprises host interface 200, which mates with removable POD module 400. As before, host interface 200 comprises tuner 205, demodulation (DEMOD) circuitry 210, quadrature phase shift keying (QPSK) transmitter (TX) 215, digital data receiver (RX) 220 demultiplexer (DEMUX) 225, MPEG video processing system 230, central processing unit (CPU) 235 and telephony interface 240. Removable POD module 400 comprises transport processing, filtering and routing circuitry 250, out-of-band (OOB) signal interface 260, in-band (INB) signal interface 265, and CPU interface 270.

Removable POD module 400 also comprises data processor 410, memory 420, optional user interface (IF) 430, RF transceiver 450, and antenna 460. Memory 420 stores user POD application program 440. Data processor 410, memory 420, and RF transceiver 450 are connected by, and communicate across, communications bus 470. RF transceiver 450 provides removable POD module 400 with a wireless communication capability that allows digital cable set-top box 150 to transmit data to, and receive data from, other devices at the subscriber premises. These other devices may include one or more personal computers equipped with wireless LAN cards or various consumer appliances that have, for example, a Bluetooth-compatible wireless capability. The wireless communication capability is particularly useful for providing Internet access via digital cable set-top box 150 to these other devices.

RF tuner 205 receives a spectrum of in-band (INB) radio frequency (RF) signals from the cable service provider and is tuned to a signal selected by the cable subscriber using the remote control. The tuned output of tuner 205 is then demodulated by QPSK demodulation circuitry 210 (using, for example, QAM demodulation) to produce a digital baseband signal that is transmitted to INB interface 265 in POD module 300.

Digital cable set-top box 150 comprises include QPSK transmitter 215, which receives from OOB interface 260 a digital baseband signal generated by POD module 400 and QPSK-modulates the digital baseband signal to produce an RF signal suitable for transmission to the cable service provider. Digital cable set-top box 150 also includes digital data receiver 220, which receives an incoming stream of digital baseband data from the cable service provider and transfers it to POD module 400 via OOB interface 260.

Signaling functions are split between host interface 200 and removable POD module 400. Host interface 200 handles open and standardized signal functions, such as RF front end processing and QPSK modulation and demodulation, and POD module 400 handles proprietary and secure functions, such as data-link and medium access control (MAC) protocols, encryption and decryption of incoming and outgoing data streams, and the like.

Transport processing, filtering and routing circuitry 250 comprises circuitry capable of decoding encrypted digital baseband streams from INB interface 265 to produce, for example, a decoded MPEG digital data stream, which is then routed back to INB interface 265 and transferred to demultiplexer 225. The demultiplexed MPEG data streams are then sent to MPEG video processing system 230, which generates a conventional television signal that is sent to television set 105. Additionally, command and data signals received by optional telephony interface 240 may be processed by CPU 235 and transmitted through CPU interface 270 to transport processing, filtering and routing circuitry 250 for use, for example, in decoding encrypted video data streams, activating pay-per-view functions, enabling the filtering of premium cable programming, and the like. CPU 235 also processes infrared (IR) control signals received from the remote control by one or both of IR sensor 115 and IR sensor 160.

In accordance with the principles of the present invention, POD module 400 provides a wireless communication capability for communication with other devices in the subscriber premises. POD module 400 may be adapted to perform specific applications according to user POD application program 440 executed by data processor 410. In the exemplary embodiment, user POD application program 440 is, among other things, a wireless communications control application that enables POD module 400 to act as a wireless server for one or more wireless-capable client devices. The user may communicate with POD module 400 using a keyboard and/or mouse coupled to user interface 430.

The wireless capability is particularly useful for two-way applications that send data to the digital cable service provider via QPSK transmitter 215 and receive data from the digital cable service provider via receiver 220 (out-of-band signals) or tuner 205 and demodulation circuitry 210 (in-band signals). Thus, two-way applications, such as e-mail and interactive video games, may be executed on a client platform that communicates with the Internet via removable POD module 400.

Additionally, POD module 400 may execute one-way applications that receive data from the cable service provider via receiver 220 or tuner 205 and demodulation circuitry 210. For example, host interface 200 of cable set-top box 150 may receive and downconvert standard AM and FM radio broadcasts transmitted by the cable service provider in standard television channels. The baseband signals of the AM and FM signals are then transferred to POD module 400, upconverted to RF signals by RF transceiver 450, and transmitted to radios throughout the subscriber premises.

As before, data processor 410 receives incoming in-band and out-of-band signals from the digital cable service provider via transport processing, filtering and routing circuitry 250 and transmits outgoing signals to the digital cable service provider via transport processing, filtering and routing circuitry 250. Data processor 410 also transmits audio and video data streams wirelessly received by RF transceiver 450 from other devices to television 105 via transport processing, filtering and routing circuitry 250 and demultiplexer 225. The format of the audio and video streams may further utilize the MPEG transport scheme or may simply be digitized baseband audio and video signals.

Although the present invention has been described in detail, those skilled in the art should understand that they can make various changes, substitutions and alterations herein without departing from the spirit and scope of the invention in its broadest form.

What is claimed is:

1. For use in a digital cable set-top box capable of being coupled to a television set, a removable circuit apparatus capable of being inserted into a point of deployment (POD) host interface associated with said digital cable set-top box, said removable circuit apparatus comprising:
a point of deployment (POD) module interface capable of mating with said POD host interface; and
a RF transceiver coupled to said POD module interface capable of receiving an incoming baseband signal from said digital cable set-top box, upconverting said baseband signal to an outgoing RF signal, and wirelessly transmitting said outgoing RF signal to at least one wireless communication device proximate said digital cable set-top box and further capable of wirelessly receiving an incoming RF signal from said at least one wireless communication device, downconverting said incoming RF signal to an outgoing baseband signal, and transmitting said outgoing baseband signal to said digital cable set-top box.

2. The removable circuit apparatus as set forth in claim 1 wherein said incoming baseband signal and said incoming RF signal comprise Internet protocol (IP) data packets.

3. The removable circuit apparatus as set forth in claim 2 further comprising:
a data processor coupled to said POD module interface and capable of transmitting to said digital cable set-top box at least one of an audio signal and a video signal capable of being displayed on a screen of said television set; and
a memory coupled to said data processor capable of storing a user POD application program executable by said data processor, where in said user POD application is operable to cause said data processor to control operation of said RF transceiver.

4. The removable circuit apparatus as set forth in claim 3 wherein said data processor is capable of receiving user input signals from said digital cable set-top box.

5. The removable circuit apparatus as set forth in claim 4 wherein said user input signals comprise infrared signals detected by an infrared sensor associated with said digital cable set-top box.

6. The removable circuit apparatus as set forth in claim 3 further comprising a user interface coupled to said data processor capable of receiving user inputs from a user input device coupled to said user interface.

7. The removable circuit apparatus as set forth in claim 6 wherein said user input device comprises a keyboard.

8. The removable circuit apparatus as set forth in claim 6 wherein said user input device comprises a mouse.

9. The removable circuit apparatus as set forth in claim 3 further comprising a disk storage device capable of storing said user POD application program.

10. The removable circuit apparatus as set forth in claim 3 further comprising a disk storage device capable of storing at least one of audio files, video files, graphics files, and text files associated with said user POD application program.

11. The removable circuit apparatus as set forth in claim 3 wherein said user POD application program further comprises a video game program.

12. The removable circuit apparatus as set forth in claim 1 wherein said user POD application program further comprises an email program.

13. For use in a digital cable set-top box capable of being coupled to a television set, a removable circuit apparatus capable of being inserted into a point of deployment (POD) host interface associated with said digital cable set-top box, said removable circuit apparatus comprising:
a point of deployment (POD) module interface capable of mating with said POD host interface; and
a RF transmitter coupled to said POD module interface capable of receiving an incoming baseband signal from said digital cable set-top box, upconverting said baseband signal to an outgoing RF signal, and wirelessly transmitting said outgoing RF signal to at least one wireless communication device proximate said digital cable set-top box.

14. The removable circuit apparatus as set forth in claim 13 wherein said incoming baseband signal comprises Internet protocol (IP) data packets.

15. The removable circuit apparatus as set forth in claim 14 further comprising:
a data processor coupled to said POD module interface and capable of transmitting to said digital cable set-top box at least one of an audio signal and a video signal capable of being displayed on a screen of said television set; and
a memory coupled to said data processor capable of storing a user POD application program executable by said data processor, wherein said user POD application is operable to cause said data processor to control operation of said RF transmitter.

16. The removable circuit apparatus as set forth in claim 15 wherein said data processor is capable of receiving user input signals from said digital cable set-top box.

17. The removable circuit apparatus as set forth in claim 16 wherein said user input signals comprise infrared signals detected by an infrared sensor associated with said digital cable set-top box.

18. The removable circuit apparatus as set forth in claim 15 further comprising a user interface coupled to said data processor capable of receiving user inputs from a user input device coupled to said user interface.

19. The removable circuit apparatus as set forth in claim 18 wherein said user input device comprises a keyboard.

20. The removable circuit apparatus as set forth in claim 18 wherein said user input device comprises a mouse.

21. The removable circuit apparatus as set forth in claim 14 wherein said IP data packets comprise at least one of AM radio baseband signals and FM radio baseband signals.
